(19) United States
(12) Patent Application Publication
(10) Pub. No.: US 2025/0123375 A1
(43) Pub. Date: Apr. 17, 2025

(54) DISTANCE MEASURING DEVICE AND EQUIPMENT

(71) Applicant: CANON KABUSHIKI KAISHA, Tokyo (JP)

(72) Inventor: KAZUHIRO MORIMOTO, Kanagawa (JP)

(21) Appl. No.: 18/906,463

(22) Filed: Oct. 4, 2024

(30) Foreign Application Priority Data
Oct. 13, 2023 (JP) 2023-177770

(51) Int. Cl. G01S 7/487; G01S 7/481; G01S 7/4865; G01S 17/10

(52) U.S. Cl. CPC G01S 7/487; G01S 7/4816; G01S 7/4865; G01S 17/10

(57) ABSTRACT

A distance measuring device is provided. The device includes a pixel region and a processor for generating distance information based on a signal output from the pixel region. A sequence of generating the distance information includes distance measuring periods each for measuring a time from emission of light to detection of the light reflected on an object by the pixel region. The processor performs tensor calculation on a tensor of two or more dimensions including a first time axis indicating a time at which a distance measuring operation in each distance measuring period is performed, and the tensor calculation is performed to obtain a calculation result indicating that each detection signal indicating that light is detected is a true detection signal when there is a signal indicating that another ray of light is detected within a predetermined range of the tensor from the detection signal.

### BACKGROUND

### Technical Field

The present disclosure relates to a distance measuring device and equipment.

### Description of the Related Art

Examples of time-resolved measurement include a known distance measuring device of a time-of-flight (ToF) method that performs distance measurement by emitting light from a light source and detecting reflected light reflected on an object. Japanese Patent Laid-Open No. 2019-144065 discloses an optical distance measuring device that generates a histogram based on pulse signals output from a plurality of light receiving elements that can output pulse signals in response to incidence of reflected light, and obtains a distance value from a peak of the histogram.

### SUMMARY

According to some embodiments, a distance measuring device comprising: a pixel region including a plurality of pixels; and a processing circuit for generating distance information based on a signal output from the pixel region, wherein a sequence of generating the distance information includes a plurality of distance measuring periods each for measuring a time from emission of light by a light source to detection of the light reflected on an object by the pixel region, the processing circuit is configured to perform, for each pixel, tensor calculation on a tensor of two or more dimensions including a first time axis indicating a time at which a distance measuring operation in each distance measuring period is performed, and the tensor calculation is performed to obtain a calculation result indicating that each detection signal indicating that light is detected is a true detection signal when there is a signal indicating that another ray of light is detected within a predetermined range of the tensor from the detection signal, is provided.

In time-resolved measurement, when noise output from the light receiving element or the like is superimposed on an effective signal, measurement accuracy is deteriorated.

Some embodiments of the present disclosure provide a technology advantageous in improvement of the accuracy of time-resolved measurement.

Further features of the present invention will become apparent from the following description of exemplary embodiments with reference to the attached drawings.

### BRIEF DESCRIPTION OF THE DRAWINGS

FIG. 1 is a view illustrating a configuration example of a distance measuring device of the present embodiment.

FIG. 2 is a view illustrating a configuration example of a pixel array of the distance measuring device of FIG. 1.

FIG. 3 is a block diagram illustrating a configuration example of a circuit substrate of the distance measuring device of FIG. 1.

FIG. 4 is a circuit diagram illustrating a configuration example of a pixel of the distance measuring device of FIG. 1.

FIGS. 5A and 5B are views illustrating operation examples of the pixel of the distance measuring device of FIG. 1.

FIG. 6 is a block diagram illustrating a configuration example of the distance measuring device of FIG. 1.

FIG. 7 is a view illustrating a processing example of the distance measuring device of FIG. 6.

FIG. 8 is a view illustrating an effect of the distance measuring device of FIG. 6.

FIGS. 9A and 9B are views illustrating effects of the distance measuring device of FIG. 6.

FIG. 10 is a view illustrating a processing example of the distance measuring device of FIG. 6.

FIGS. 11A and 11B are views illustrating the effects of the distance measuring device of FIG. 6.

FIG. 12 is a view illustrating a processing example of the distance measuring device of FIG. 6.

FIG. 13 is a view illustrating a processing example of the distance measuring device of FIG. 6.

FIG. 14 is a block diagram illustrating a configuration example of the distance measuring device of FIG. 1.

FIG. 15 is a view illustrating a processing example of the distance measuring device of FIG. 14.

FIG. 16 is a view illustrating a configuration example of equipment incorporated with a photoelectric conversion device according to the present embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

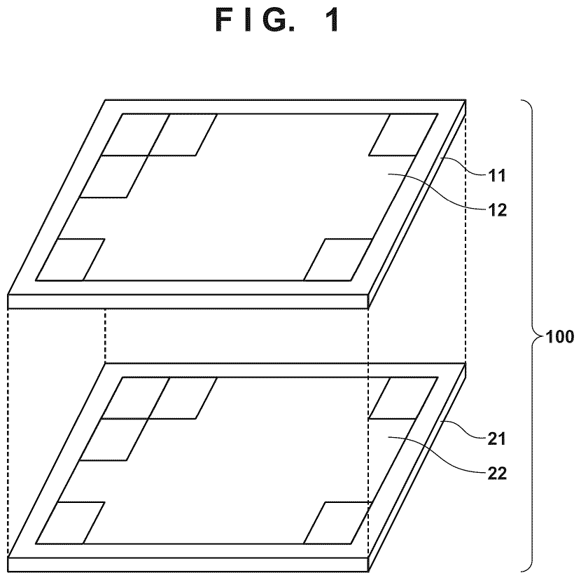

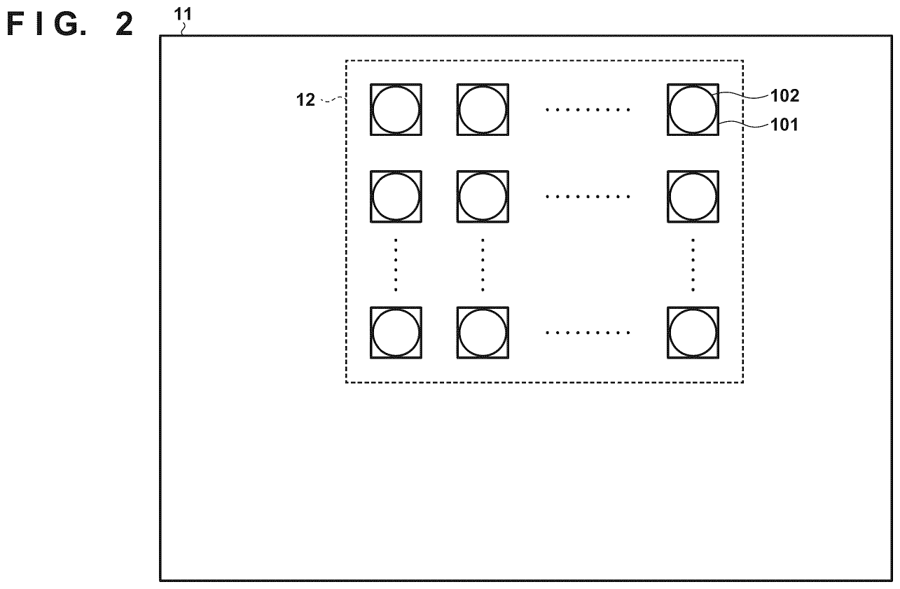

First, with reference to FIGS. 1 to 5, an avalanche photodiode (hereinafter, sometimes indicated as APD) that can be used in a distance measuring device 100 described below will be described. FIG. 1 is a view illustrating a configuration example of the distance measuring device 100. The distance measuring device 100 can be configured by layering and electrically connecting two substrates of a sensor substrate 11 and a circuit substrate 21. That is, the distance measuring device 100 may be a layered device. In the sensor substrate 11, a pixel region 12 including a plurality of pixels 101 (illustrated in FIG. 2) is arranged. In the circuit substrate 21, a circuit region 22 for processing a signal detected in the pixel region 12 is arranged.

FIG. 2 is a view illustrating an arrangement example of the sensor substrate 11. The pixels 101 having a photoelectric conversion element 102 including the APD are arrayed in a two-dimensional array (matrix) and form the pixel region 12. The pixel 101 is typically a pixel for generating an image, but needs not necessarily generate an image when used in a distance measuring device of a time of flight (ToF) method or the like. That is, the pixel 101 may be configured to measure the time when light reaches and a light amount.

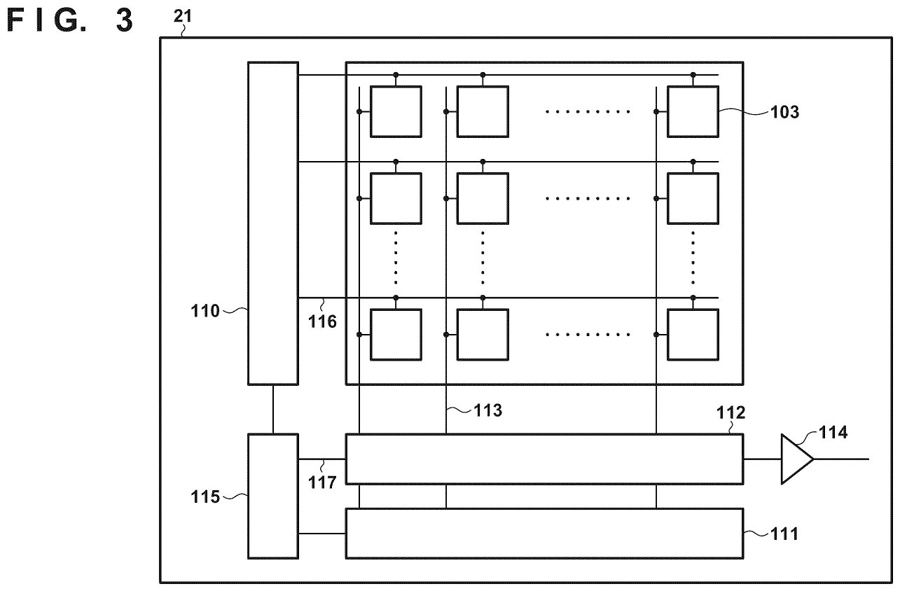

FIG. 3 is a view illustrating a configuration example of the circuit substrate 21. The circuit substrate 21 includes a signal processing circuit 103 that processes a charge photoelectrically converted by the photoelectric conversion element 102 illustrated in FIG. 2, a readout circuit 112, a control pulse generation circuit 115, a horizontal scan circuit 111, a signal line 113, and a vertical scan circuit 110. The signal processing circuit 103 illustrated in FIG. 3 may be arranged so as to correspond to each of the pixels 101 illustrated in FIG. 2. In that case, the pixel 101 (photoelectric conversion element 102) and the signal processing circuit 103 may be electrically connected via a connection wiring provided for each of the pixels 101.

The vertical scan circuit 110 receives a control pulse supplied from the control pulse generation circuit 115 and supplies the control pulse to each of the pixels 101. As the vertical scan circuit 110, a logic circuit such as a shift register or an address decoder can be used.

The signal output from the pixel 101 is processed by the signal processing circuit 103. The signal processing circuit 103 can be provided with a counter, a memory, and the like. A count value counted by the counter can be held as a digital value in the memory.

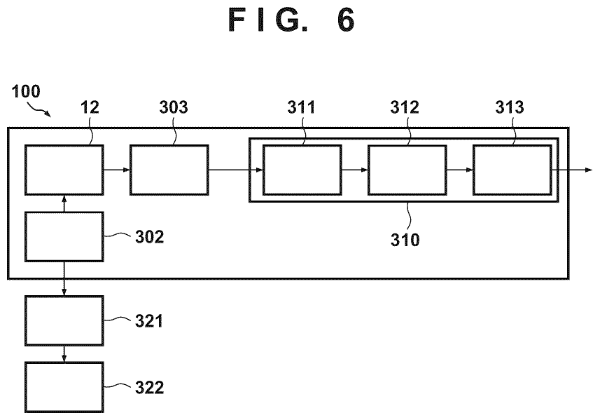

The horizontal scan circuit 111 inputs a control pulse for sequentially selecting each column to the signal processing circuit 103 in order to read a signal from the memory of the signal processing circuit 103 corresponding to each of the pixels 101 in which the digital signal is held. For the selected column, a signal is output to the signal line 113 from the signal processing circuit 103 corresponding to the pixel 101 selected by the vertical scan circuit 110. The signal output to the signal line 113 is output to a processing circuit 310 (explained with reference to FIG. 6 and subsequent drawings) of the distance measuring device 100 via an output circuit 114.

The arrangement of the pixels 101 in the pixel region 12 illustrated in FIG. 2 should not be construed in a limiting sense to a two-dimensional array. The pixels 101 may be arranged one-dimensionally. The function of the signal processing circuit 103 is not necessarily provided in all the pixels 101 (photoelectric conversion elements 102) one by one, and for example, one signal processing circuit 103 may be shared by the plurality of pixels 101 (photoelectric conversion elements 102) and signal processing may be sequentially performed.

As illustrated in FIGS. 2 and 3, a plurality of the signal processing circuits 103 can be arranged in a region overlapping the pixel region 12 in orthogonal projection to the pixel region 12. The vertical scan circuit 110, the horizontal scan circuit 111, the readout circuit 112, the output circuit 114, the control pulse generation circuit 115, and the like can be arranged to overlap between an end of the sensor substrate 11 and an end of the pixel region 12. In other words, the sensor substrate 11 has the pixel region 12 and a non-pixel region arranged around the pixel region 12. In that case, the vertical scan circuit 110, the horizontal scan circuit 111, the readout circuit 112, the output circuit 114, and the control pulse generation circuit 115 can be arranged in a region overlapping the non-pixel region.

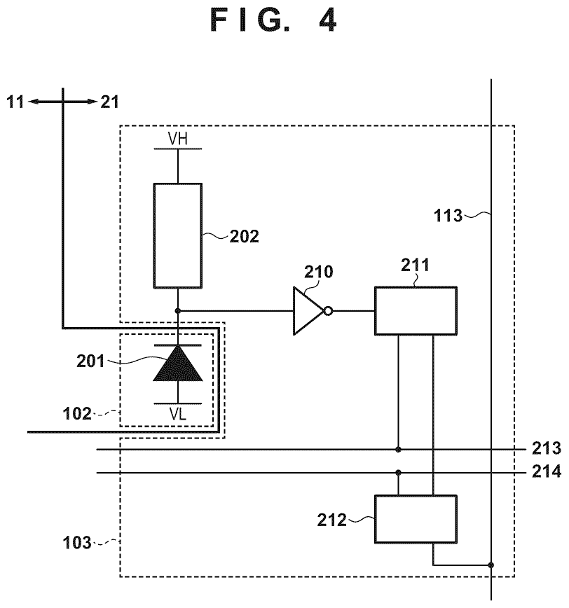

FIG. 4 is an example of a block diagram including an equivalent circuit focusing on one pixel 101 (photoelectric conversion element 102). In FIG. 4, the photoelectric conversion element 102 including an APD 201 is provided on the sensor substrate 11, and the other configurations are provided on the circuit substrate 21.

The APD 201 generates a charge pair corresponding to incident light by photoelectric conversion. An anode of the APD 201 is supplied with a potential VL. A cathode of the APD 201 is supplied with a potential VH higher than the potential VL supplied to the anode. The anode and the cathode are supplied with a reverse bias voltage so that the APD 201 performs an avalanche multiplication operation. By bringing into a state of supplying such a reverse bias voltage, the charge generated by the incident light causes avalanche multiplication, and an avalanche current is generated.

In a case where a reverse bias voltage is supplied to the APD 201, there are a Geiger mode in which operation is performed with a potential difference (voltage) between the anode and the cathode being larger than a breakdown voltage, and a linear mode in which operation is performed with a potential difference between the anode and the cathode being in the vicinity of the breakdown voltage or equal to or less than the breakdown voltage. An APD operated in the Geiger mode is called a single photon avalanche diode (SPAD). For example, the potential VL is −30 V, and the potential VH is 1 V. The APD 201 may be operated in the linear mode or may be operated in the Geiger mode.

A quench element 202 is connected between a power source that supplies the potential VH and the APD 201. The quench element 202 functions as a load circuit (quench circuit) at the time of signal multiplication by avalanche multiplication, and suppresses avalanche multiplication by suppressing the voltage supplied to the APD 201 (quench operation). By passing a current corresponding to a voltage drop in the quench operation, the quench element 202 returns the voltage supplied to the APD 201 to the voltage (VH-VL) (recharge operation).

The signal processing circuit 103 can include a waveform shaping circuit 210, a counter circuit 211, and a selection circuit 212. In the present description, the signal processing circuit 103 may include any of the waveform shaping circuit 210, the counter circuit 211, and the selection circuit 212.

The waveform shaping circuit 210 shapes a potential change of the cathode of the APD 201 obtained at the time of photon detection, and outputs a pulse signal. For example, an inverter circuit is used as the waveform shaping circuit 210. In the configuration illustrated in FIG. 4, an example in which one inverter is used as the waveform shaping circuit 210 is illustrated. However, this should not be construed in a limiting sense, and a circuit in which a plurality of inverters are connected in series may be used as the waveform shaping circuit 210, or another circuit having a waveform shaping effect may be used.

The counter circuit 211 counts the pulse signal output from the waveform shaping circuit 210 and holds a count value. When a control pulse pRES is supplied from the vertical scan circuit 110 via a drive line 213, the signal held in the counter circuit 211 is reset.

The selection circuit 212 is supplied with a control pulse pSEL from the vertical scan circuit 110 illustrated in FIG. 3 via a drive line 214 illustrated in FIG. 4, and electrical connection/disconnection between the counter circuit 211 and the signal line 113 is switched. The selection circuit 212 includes a buffer circuit for outputting a signal, for example.

A switch element such as a transistor may be arranged between the quench element 202 and the APD 201 or between the photoelectric conversion element 102 and the signal processing circuit 103, so that electrical connection can be switched. Similarly, supply of the potential VH or the potential VL to be supplied to the photoelectric conversion element 102 may be electrically switchable using a switch element such as a transistor.

In the present embodiment, a configuration in which the counter circuit 211 is arranged in the signal processing circuit 103 has been described. However, this should not be construed in a limiting sense, and the distance measuring device 100 may be configured to acquire pulse detection timing by using a time-to-digital conversion circuit (TDC) and the memory in place of the counter circuit 211. In that case, generation timing of the pulse signal output from the waveform shaping circuit 210 is converted into a digital signal by the TDC. The TDC is supplied with a control pulse pREF (reference signal) from the vertical scan circuit 110 via a drive line for measurement of the timing of the pulse signal. With reference to the control pulse pREF, the TDC acquires, as a digital signal, a signal when input timing of the signal output from each of the pixels 101 via the waveform shaping circuit 210 is a relative time.

In the configuration illustrated in FIG. 4, an example in which the quench element 202, the waveform shaping circuit 210, the counter circuit 211, and the selection circuit 212 are arranged on one circuit substrate 21 has been described, but this should not be construed in a limiting sense. For example, the quench element 202 and the waveform shaping circuit 210 may be arranged on one substrate, the counter circuit 211 and the selection circuit 212 may be arranged on another substrate, and these substrates may be layered.

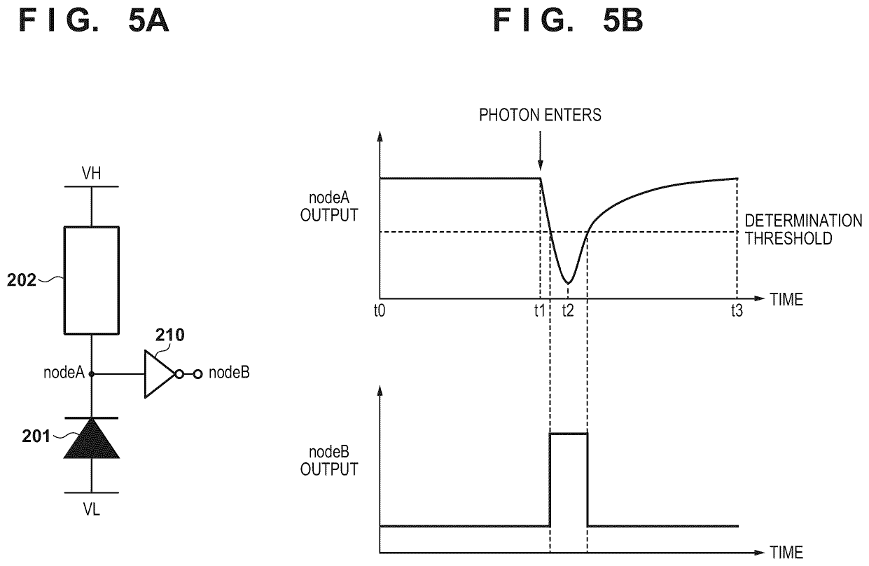

FIGS. 5A and 5B are views schematically illustrating a relationship between an operation of the APD 201 and an output signal. FIG. 5A is a view in which the APD 201, the quench element 202, and the waveform shaping circuit 210 illustrated in FIG. 4 are extracted. Here, let an input side of the waveform shaping circuit 210 be node A, and an output side thereof be node B. FIG. 5B illustrates waveform changes of node A and node B.

From time t0 to time t1, the APD 201 is applied with a potential difference (voltage) between the potential VH and the potential VL. When a photon enters the APD 201 at time t1, avalanche multiplication occurs in the APD 201, an avalanche multiplication current flows through the quench element 202, and the potential of node A drops. When the voltage drop further increases and the potential difference applied to the APD 201 decreases, the avalanche multiplication of the APD 201 stops as shown at time t2, and the potential level of node A does not drop by a certain value or more. Thereafter, between time t2 and time t3, a current for compensating for the voltage drop from the potential VL flows in node A, and node A settles to the original potential level at time t3. At this time, a part where the output waveform exceeds a certain threshold in node A is waveform-shaped by the waveform shaping circuit 210 and is output as a signal to node B.

The arrangement of the signal line 113, the readout circuit 112, and the output circuit 114 is not limited to the configuration illustrated in FIG. 3. For example, the signal line 113 may be arranged to extend in a row direction (lateral direction in FIG. 3), and the readout circuit 112 may be arranged in a destination where the signal line 113 extends.

Next, the processing circuit 310 arranged in the distance measuring device 100 of the present embodiment will be described in detail. FIG. 6 is a block diagram illustrating a configuration example of the distance measuring device 100 of the present embodiment. The distance measuring device 100 illustrated in FIG. 6 can be a distance measuring device using a so-called Direct Time of Flight (D-ToF) method.

The distance measuring device 100 includes the pixel region 12 including the above-described pixels 101, a control circuit 302, a readout circuit 303, and the processing circuit 310. The control circuit 302 can be, for example, a timing generator that controls each configuration of the distance measuring device 100. The control circuit 302 may be a timing control circuit using an FPGA or the like. The control circuit 302 controls, together with the distance measuring device 100, a light source control circuit 321 that controls a light source 322 (e.g., it can be an edge emitting laser or a vertical cavity surface emitting laser) that emits light to perform distance measurement of an object. In the configuration illustrated in FIG. 6, the control circuit 302 is incorporated in the distance measuring device 100, but the control circuit 302 may be arranged outside the distance measuring device 100. In that case, each operation of the distance measuring device 100 is controlled in response to a signal input from the outside of the distance measuring device 100. The readout circuit 303 can include the readout circuit 112 and the output circuit 114 described above. The readout circuit 303 is a circuit for reading out a signal generated in the pixel region 12 to the processing circuit 310.

The processing circuit 310 generates distance information based on a signal output from the pixel region 12. The processing circuit 310 can include, for example, a storage circuit 311, a filter circuit 312, and a generation circuit 313. The storage circuit 311 can be, for example, a memory such as SRAM, DRAM, or MRAM, or a digital counter. The storage circuit 311 stores a signal read out from the pixel region 12. Although described in detail later, the filter circuit 312 performs tensor calculation on multi-dimensional binary data stored in the storage circuit 311. The generation circuit 313 generates distance information based on data after the tensor calculation output from the filter circuit 312. The processing circuit 310 may be arranged in the circuit region 22 of the circuit substrate 21, or may be arranged on another substrate layered with the sensor substrate 11 and the circuit substrate 21.

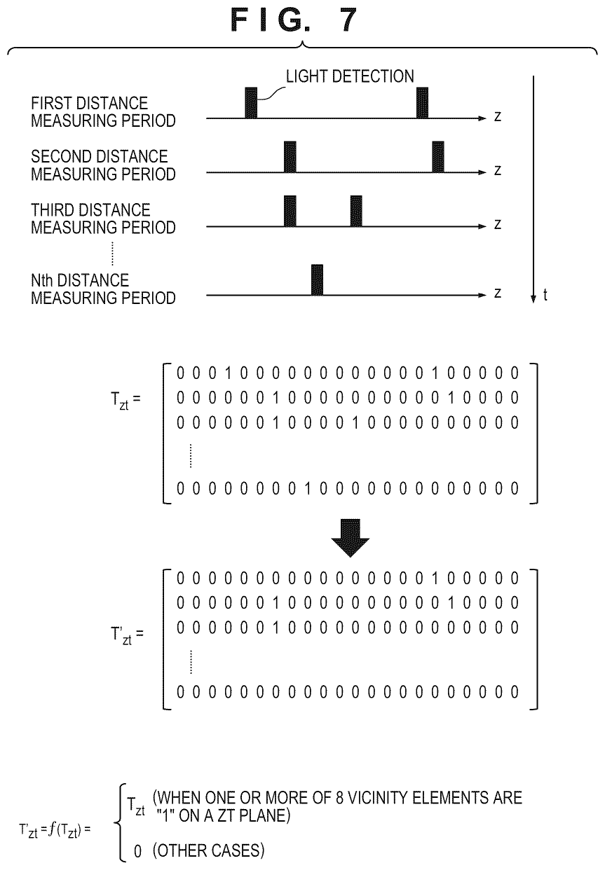

FIG. 7 is a view explaining processing performed in the filter circuit 312 arranged in the processing circuit 310. In the distance measuring device 100, a sequence of generating distance information such as the distance to the object includes a plurality of distance measuring periods each for measuring a time from emission of light by the light source 322 to detection of the light reflected on an object by the pixel region 12. FIG. 7 focuses on one pixel 101 among the pixels 101 arranged in the pixel region 12. In each distance measuring period, when detecting light, the pixel 101 outputs a pulse signal (hereinafter, sometimes indicated as detection signal) as described above. A time axis z indicating the timing at which light is detected is divided for each predetermined time, and the timing measurement may be performed by, for example, a time-to-digital converter circuit or a time-gating operation.

This distance measuring period is repeated, and for example, the number of times of outputting the detection signal is added in the direction of a time axis t indicating the time when the distance measuring operation in which each distance measuring period is performed is performed, and a histogram is generated. Distance measurement to the object is performed in each pixel 101 from a peak position of this histogram.

FIG. 7 illustrates a tensor T_{zt} of the time axis t indicating the time at which the distance measuring operation is performed in each distance measuring period and the time axis z indicating the timing at which light is detected in each distance measuring period. Each element of the tensor T_{zt} is indicated as “1” when light is detected (detection signal is output) and “0” when no light is detected. In a case where light reflected on the object is detected, the light can be detected at the same or close timing in each distance measuring period. On the other hand, external light can be detected at random timing. Therefore, the filter circuit 312 of the processing circuit 310 performs tensor calculation on a tensor of two or more dimensions including the time axis t indicating the time at which the distance measuring operation in each distance measuring period is performed in each pixel 101. The tensor calculation performed by the filter circuit 312 is performed to obtain a calculation result indicating that each detection signal (indicated as “detection of light” in FIG. 2) indicating that light is detected is a true detection signal when there is a signal indicating that another ray of light is detected within a predetermined range of the tensor from the detection signal.

In the example illustrated in FIG. 7, the filter circuit 312 performs a two-dimensional tensor calculation on the tensor T_{zt} including the time axis t indicating the time at which the distance measuring operation in each distance measuring period is performed and the time axis z indicating the timing at which light is detected in each distance measuring period, and generates a tensor T′_{zt}, which is data after the calculation. For example, in the tensor T_{zt}, when one or more of 8 vicinity elements are “1” with respect to the element of the detection signal (“1”) of interest on a zt plane, the calculation result of the element remains “1”. As a result, the calculation is performed as if the filter circuit 312 determines that the detection signal of the element is a true detection signal. On the other hand, when there is no “1” in the 8 vicinity elements with respect to the element of the detection signal (“1”) of interest on the zt plane, the calculation result of the element is replaced with “0”. As a result, the calculation is performed as if the filter circuit 312 determines that the detection signal of the element is a random signal such as external light. Due to this, for example, filtering can be performed in the dimension direction of the time axis t before generating the histogram for obtaining the distance information. In the example illustrated in FIG. 7, filtering can be performed also in the dimension direction of the time axis z. In the present embodiment, a photon detection event is expressed as binary data of “1” or “0”, but for the purpose of data compression and speed-up, for example, a combination of time stamp information and address information corresponding to each photon detection event may be stored in the storage circuit 311, and filter processing mathematically equivalent to the above may be performed without performing conversion into binary data. Specifically, for a plurality of combinations of time stamp information and address information, the presence or absence of photon detection events close to each other in the time axis z and the time axis t is searched, and a signal regarded as external light is filtered, whereby processing equivalent to the filtering processing for the binary data described above can be performed.

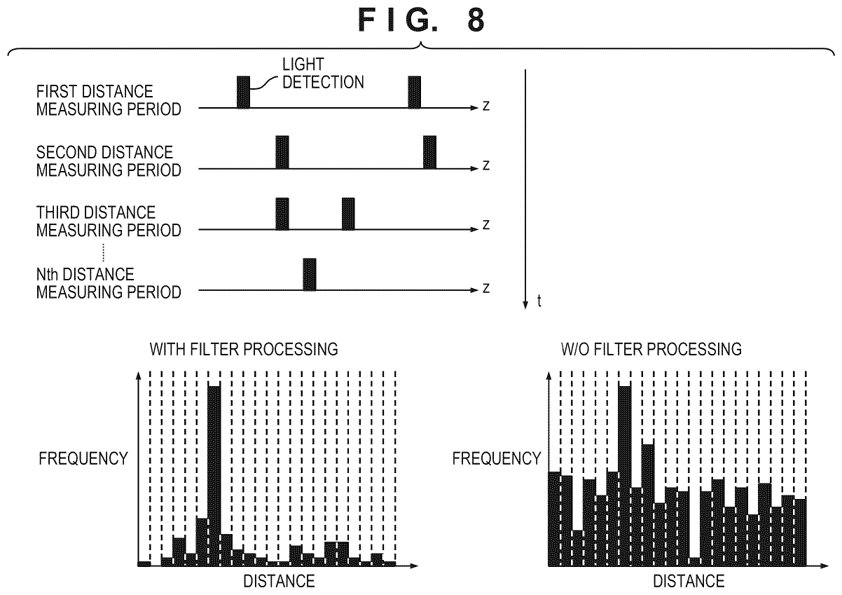

FIG. 8 is a view illustrating an effect of the present embodiment. As described above, the processing circuit 310 includes the filter circuit 312 that performs the tensor calculation on the tensor, and the generation circuit 313 for generating the distance information based on data after the tensor calculation, the data being output from the filter circuit and being obtained in a predetermined number of distance measuring periods among the plurality of distance measuring periods. For example, the generation circuit 313 generates, as the distance information, a histogram in which elements arranged in the direction of the time axis t of the data after the tensor calculation are added. When there is no filtering processing by the filter circuit 312, the background increases due to a randomly detected signal as indicated by “filtering processing absent” in the lower right part of FIG. 8. On the other hand, when the filter processing is performed by the filter circuit 312 (“filter processing present” in the lower left of FIG. 8), the background is lowered, and a peak at which light reflected on an object is detected is easily detected. That is, information such as the distance to the object is easily obtained from the histogram indicating the distance information. As a result, the accuracy of distance measuring is improved.

An appropriate range is set as a predetermined range for performing calculation (determination) whether or not the detection signal of interest is a true detection signal. In the example illustrated in FIG. 7, the range in the direction along the time axis t in the tensor is the distance measuring periods adjacent to each other, and the range in the direction along the time axis z in the tensor is the detection timings adjacent to each other. In this case, when there is a signal indicating that another ray of light is detected in at least one of the range in the direction along the time axis t of the tensor and the range in the direction along the time axis z from the detection signal, the filter circuit 312 of the processing circuit 310 performs calculation to obtain an calculation result indicative of a true detection signal. However, the predetermined range for performing calculation (determination) whether or not to be a true detection signal should not be construed in a limiting sense. For example, as a range in the direction along the time axis t of the tensor, two or more distance measuring periods such as two before and two after in the direction of the time axis t may be set. The range in the direction along the time axis t of the tensor may be, for example, three or five before and three or five after in the direction of the time axis t. In this case, even when the detection signal is not output in the distance measuring periods one before and one after, if the detection signal is output in the distance measuring periods two before and two after or the like, the filter circuit 312 obtains a calculation result indicative of a true detection signal. The same applies to the time axis z.

For example, the number of elements of the tensor included in a range in the direction along the time axis t and the number of elements of the tensor included in a range in the direction along the time axis z may be different from each other. By changing the filter size in accordance with the resolution with the time axis t and the time axis z, there is a possibility of improvement in the distinction accuracy between the signal and the noise.

The generation circuit 313 generates distance information based on data after the tensor calculation output from the filter circuit 312 and obtained in a predetermined number of distance measuring periods among the plurality of distance measuring periods. For example, in the examples illustrated in FIGS. 7 and 8, the generation circuit 313 generates a histogram as distance measuring information from data obtained from the first distance measuring period to the N-th distance measuring period. The predetermined number of distance measuring periods used by the generation circuit 313 to generate the distance information may be consecutive distance measuring periods among the plurality of distance measuring periods. Next, the generation circuit 313 may generate a histogram from data obtained, for example, in the (N+1)-th distance measuring period to the (N+N)-th distance measuring period. For example, the generation circuit 313 may generate a histogram from data obtained from the first distance measuring period to the N-th distance measuring period, and then generate a histogram from data obtained from the second distance measuring period to the (N+1)-th distance measuring period. In the sequence of generating the distance information, the generation circuit 313 can generate a plurality of pieces of distance information from a plurality of distance measuring periods that are repeated. At this time, a part of a predetermined number of distance measuring periods used for generation of a certain piece of distance information among the plurality of distance measuring periods and a part of a predetermined number of distance measuring periods used for generation of a subsequent piece of distance information among the plurality of distance measuring periods may be the distance measuring period same as each other.

Here, a case where the generation circuit 313 generates a histogram from data obtained from the first distance measuring period to the N-th distance measuring period in which tensor calculation is performed by the filter circuit 312 will be considered. In this case, the filter circuit 312 may set the range in which the tensor calculation is performed in the direction along the time axis t to a range included in the first distance measuring period to the N-th distance measuring period. For example, the filter circuit 312 may perform the tensor calculation on an element obtained in the N-th distance measuring period by using, for example, an element obtained in the (N+1)-th or after the (N+1)-th distance measuring period. That is, the range in the direction of the time axis t of the distance measuring period used by the filter circuit 312 to perform the tensor calculation may be different from the range in the direction of the time axis t of the distance measuring period used by the generation circuit 313 to generate the distance information.

In the example illustrated in FIG. 7, it has been described that the filter circuit 312 performs tensor calculation (filtering) using two-dimensional blob detection, but this should not be construed in a limiting sense. The tensor calculation may be any of pattern matching, a combination of expansion processing and reduction processing, reduction processing, and thinning processing. Any of a median filter, a maximum value filter, a minimum value filter, and a moving average filter may be used for the tensor calculation.

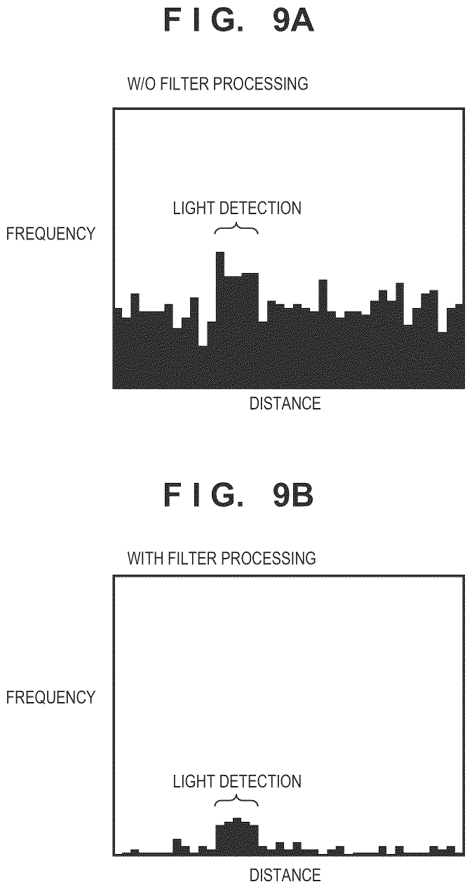

FIGS. 7 and 8 illustrate examples in which an object does not move during one operation of acquiring distance information (e.g., from the first distance measuring period to the N-th distance measuring period). On the other hand, during one operation of acquiring the histogram, the object may move in the direction of a distance z. As illustrated in FIGS. 9A and 9B, when the object moves, the peak of signal light becomes broad and the height decreases as compared with a case where the object is stationary. This makes it difficult to distinguish between the signal and the external light, and the distance measuring accuracy may be deteriorated. However, as illustrated in FIG. 9B, before the histogram is generated, filtering is performed using a distance measuring result at a close time (time axis t) to remove external light. Due to this, as compared with a case of not performing filtering by the filter circuit 312 illustrated in FIG. 9A, it is possible to effectively suppress external light, and enhance detection accuracy of light reflected on the object.

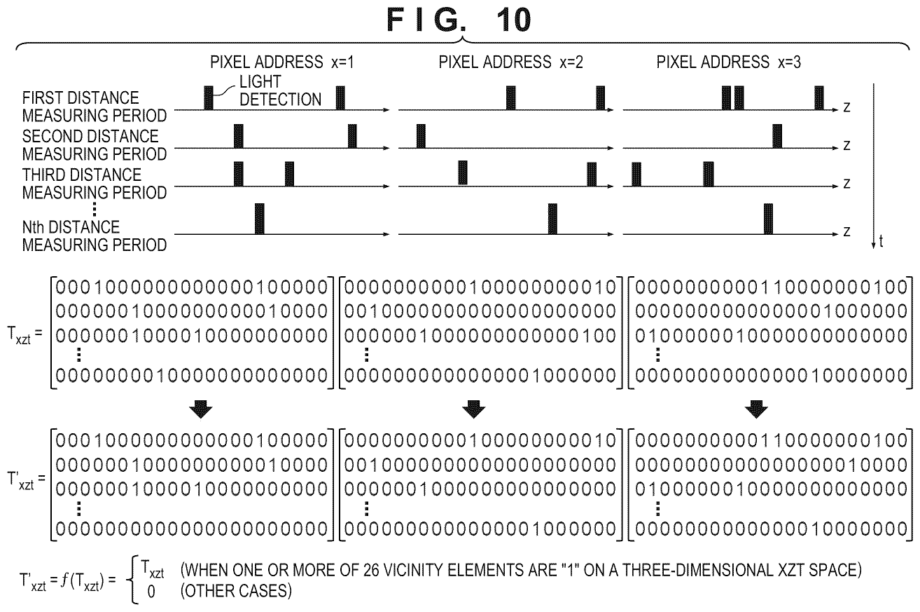

In the above, it has been described that the filter circuit 312 performs the tensor calculation on the two-dimensional tensor T_{zt} including the time axis t and the time axis z. However, this should not be construed in a limiting sense. The plurality of pixels 101 are arranged in a matrix. The tensor may further include a space axis x indicating a row or a column in which the plurality of pixels 101 are arranged. FIG. 10 illustrates an example in which the filter circuit 312 performs tensor calculation on a three-dimensional tensor T_{xzt} including the time axis t, the time axis z, and the space axis x. For example, in the tensor T_{xzt}, when one or more of 26 vicinity elements are “1” with respect to the element of the detection signal (“1”) of interest on a three-dimensional xzt space of the time axis t, the time axis z, and the space axis x, the calculation result of the element remains “1”. As a result, the calculation is performed as if the filter circuit 312 determines that the detection signal of the element is a true detection signal. On the other hand, when there is no “1” in the 26 vicinity elements with respect to the element of the detection signal (“1”) of interest on the xzt plane, the calculation result of the element is replaced with “0”. As a result, the calculation is performed as if the filter circuit 312 determines that the detection signal of the element is a random signal such as external light. By filtering the three-dimensional tensor, components such as random external light having a weak correlation between time and space are effectively removed, and the distance measuring accuracy can be improved.

Similarly to the filtering on the two-dimensional tensor, an appropriate range is set as a predetermined range for performing calculation (determination) whether or not the detection signal of interest is a true detection signal. In the example illustrated in FIG. 10, the range in the direction along the time axis t in the tensor is the distance measuring periods adjacent to each other, the range in the direction along the time axis z in the tensor is the detection timings adjacent to each other, and the range in the direction along the space axis x in the tensor is the pixels 101 adjacent to each other. However, this should not be construed in a limiting sense. For example, as a range in the direction along the time axis t of the tensor, two or more distance measuring periods such as two before and two after in the direction of the time axis t may be set. For example, as a range in the direction along the space axis x of the tensor, two or more pixels 101 such as two before and two after in the direction of the time axis x may be set. The range in the direction along the space axis x of the tensor may be, for example, three or five before and three or five after in the direction of the space axis x.

For example, the number of elements of the tensor included in a range in the direction along the time axis t and the number of elements of the tensor included in a range in the direction along the space axis x may be different from each other. By changing the filter size in accordance with the time resolution of the time axis t and the spatial resolution with a space axis x, there is a possibility of improvement in the distinction accuracy between the signal and the noise. The number of elements of the tensor included in a range in the direction along the time axis z and the number of elements of the tensor included in a range in the direction along the space axis x may be different from each other.

FIG. 11A illustrates a histogram generated by the generation circuit 313 for data after tensor calculation performed by the filter circuit 312 on a two-dimensional tensor. FIG. 11B illustrates a histogram generated by the generation circuit 313 for data after tensor calculation performed by the filter circuit 312 on a three-dimensional tensor. It is found that an increase in the number of dimensions for filtering improves the accuracy of distinguishing between a signal and noise.

In the example illustrated in FIG. 10, it has been described that the filter circuit 312 performs tensor calculation (filtering) using three-dimensional blob detection, but this should not be construed in a limiting sense. The tensor calculation may be any of pattern matching, a combination of expansion processing and reduction processing, reduction processing, and thinning processing. Either a Dian filter or a moving average filter may be used for the tensor calculation.

The example illustrated in FIG. 10 illustrates an example in which the filter circuit 312 performs tensor calculation on a three-dimensional tensor T_{xzt} including the time axis t, the time axis z, and the space axis x. However, this should not be construed in a limiting sense. The tensor can further include a space axis y indicating a surface on which the plurality of pixels 101 are arranged being combined with the space axis x. Therefore, the filter circuit 312 may perform tensor calculation on a three-dimensional tensor T_{xyt} including the time axis t, the space axis x, and the space axis y.

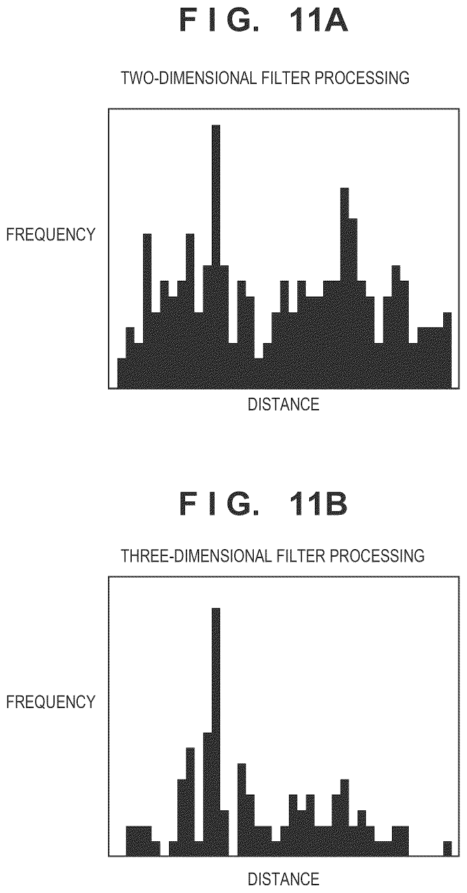

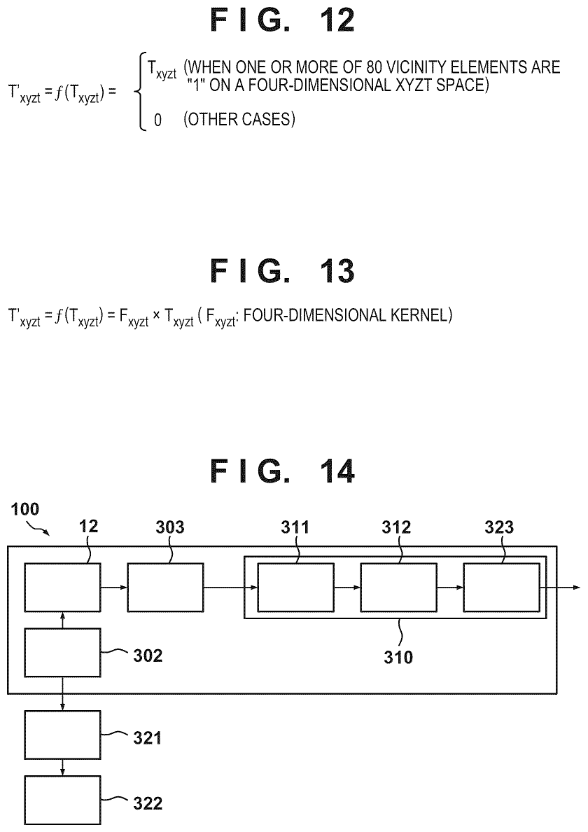

Furthermore, as illustrated in FIG. 12, the filter circuit 312 may perform tensor calculation on a four-dimensional tensor T_{xyzt} including the time axis t, the time axis z, the space axis x, and the space axis y. For example, in the tensor T_{xyzt}, when one or more of 80 vicinity elements are “1” with respect to the element of the detection signal (“1”) of interest on a four-dimensional xyzt space of the time axis t, the time axis z, the space axis x, and the space axis y, the calculation result of the element remains “1”. As a result, the calculation is performed as if the filter circuit 312 determines that the detection signal of the element is a true detection signal. On the other hand, when there is no “1” in the 80 vicinity elements with respect to the element of the detection signal (“1”) of interest on the xyzt plane, the calculation result of the element is replaced with “0”. As a result, the calculation is performed as if the filter circuit 312 determines that the detection signal of the element is a random signal such as external light. By filtering the four-dimensional tensor, components such as random external light having a weak correlation between time and space are further effectively removed, and the distance measuring accuracy can be improved.

Similarly to the filtering on the two-dimensional and three-dimensional tensors, an appropriate range is set as a predetermined range for performing calculation (determination) whether or not the detection signal of interest is a true detection signal. In the example illustrated in FIG. 12, the range in the direction along the time axis t in the tensor is the distance measuring periods adjacent to each other, the range in the direction along the time axis z in the tensor is the detection timings adjacent to each other, the range in the direction along the space axis x in the tensor is the pixels 101 adjacent to each other, and the range in the direction along the space axis y in the tensor is the pixels 101 adjacent to each other. However, this should not be construed in a limiting sense. For example, as a range in the direction along the time axis t of the tensor, two or more distance measuring periods such as two before and two after in the direction of the time axis t may be set. For example, as a range in the direction along the space axis x of the tensor, two or more pixels 101 such as two before and two after in the direction of the time axis x may be set. Furthermore, for example, as a range in the direction along the space axis y of the tensor, two or more pixels 101 such as two before and two after in the direction of the time axis y may be set. The range in the direction along the space axis y of the tensor may be, for example, three or five before and three or five after in the direction of the space axis y.

For example, the number of elements of the tensor included in a range in the direction along the time axis t and the number of elements of the tensor included in a range in the directions along the space axes x and y may be different from each other. By changing the filter size in accordance with the time resolution of the time axis t and the spatial resolution with the space axes x and y, there is a possibility of improvement in the distinction accuracy between the signal and the noise. The number of elements of the tensor included in a range in the direction along the time axis z and the number of elements of the tensor included in a range in the direction along the space axes x and y may be different from each other. The number of elements of the tensor included in a range of the direction along the space axis x and the number of elements of the tensor included in a range of the direction along the space axis y may be the same as or different from each other.

In the example illustrated in FIG. 12, it has been described that the filter circuit 312 performs tensor calculation (filtering) using three-dimensional blob detection, but this should not be construed in a limiting sense. The tensor calculation may be any of pattern matching, a combination of expansion processing and reduction processing, reduction processing, and thinning processing. Either a Dian filter or a moving average filter may be used for the tensor calculation.

In the above, so-called pattern recognition processing such as blob detection in binary data of the zt plane, the xzt space, the xyt space, and the xyzt space has been described. However, this should not be construed in a limiting sense. By performing a convolution operation, the filter circuit 312 may output floating point-type tensor data to the generation circuit 313 as data after tensor calculation. For example, as illustrated in FIG. 13, a convolution operation of a 4-dimensional kernel is performed on 4-dimensional binary data (tensor T_{xyzt}). This can obtain effects such as smoothing and edge enhancement. For example, by obtaining the effect of edge enhancement, it is easy to find a part where an output frequency of a detection signal is high. This can improve the distance measuring accuracy with respect to the distance information output from the processing circuit 310. The dimension of the kernel at the time of performing the convolution operation should not be construed in a limiting sense to the four-dimensional kernel as illustrated in FIG. 13, and may be a two-dimensional kernel or a three-dimensional kernel. The convolution operation may be performed using a plurality of different kernels in order. The filter circuit 312 may perform not only the convolution operation but also contour detection processing as tensor calculation. This also can obtain effects such as smoothing and edge enhancement.

FIG. 14 is a block diagram illustrating a modification of the distance measuring device 100 illustrated in FIG. 6. In the distance measuring device 100 illustrated in FIG. 14, the generation circuit 313 arranged in the processing circuit 310 is changed to a generation circuit 323. The rest may be similar to the configuration illustrated in FIG. 6, and thus the generation circuit 323 will be mainly described here.

It has been described that the generation circuit 313 generates a histogram as distance information for data output from the filter circuit 312. From the histogram, for example, it is possible to acquire information such as the distance from the distance measuring device 100 to the object from the peak position of the signal and light intensity information and data reliability from the relationship between the signal and noise. On the other hand, the generation circuit 323 of the processing circuit 310 arranged in the distance measuring device 100 illustrated in FIG. 14 directly extracts a feature amount without converting data after tensor calculation by the filter circuit 312 into a histogram.

More specifically, the generation circuit 323 generates distance information using calculation of the neural network for the data after the tensor calculation by the filter circuit 312. The calculation of the neural network is performed using, for example, a learned model learned using a convolutional neural network-based (CNN-based) machine learning method. This can obtain information such as the distance from the distance measuring device 100 to the object, light intensity information, and data reliability.

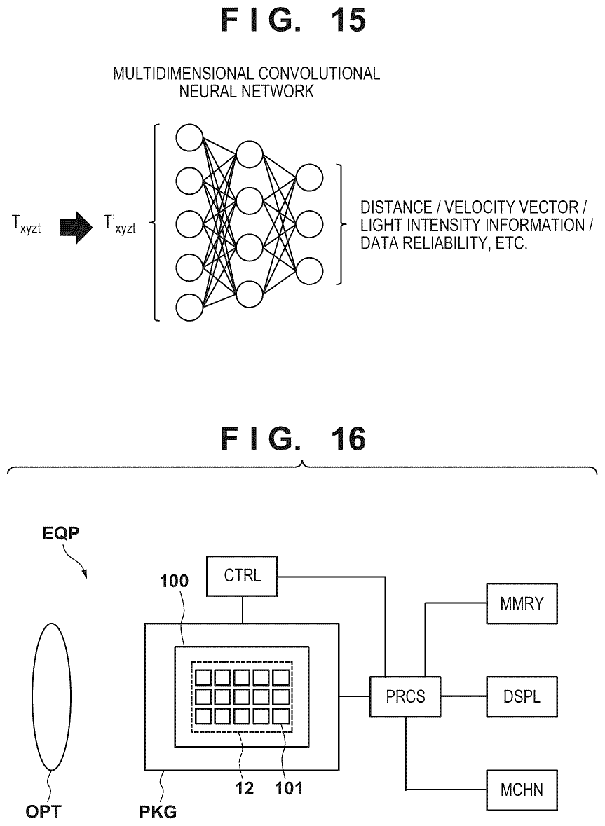

As illustrated in FIG. 15, the generation circuit 323 performs calculation using, for example, CNN with, as input data, T′_{zt}, T′_{xzt}, T′_{xyt}, and T′_{xyzt}, which are data after the tensor calculation output from the above-described filter circuit 312. This can obtain information such as the distance, light intensity information, and data reliability without generating a histogram as distance information. That is, use of calculation of the neural network speeds up the time until the distance measuring device 100 generates distance measuring information. Use of calculation of the neural network enables, as distance information, a velocity vector moving in the x, y, and z directions of the object or an optical flow to be acquired in addition to the above-described information. This can further improve the distance measuring accuracy in the distance measuring device 100. In addition, acquisition of an object recognition result, an event detection result, and the like can achieve data compression and speed-up at the time of distance measuring.

In each of the above-described embodiments, it has been described that the distance measuring accuracy is improved by performing tensor calculation using the filter circuit 312. However, the above-described embodiments can be applied to other fields as long as time-resolved measurement of a response to light (e.g., pulsed light or the like) is performed. For example, when light absorption, emission, or the like is measured as a function of time, such as fluorescence lifetime imaging in the biological field or time-resolved Raman spectrometry in the scientific measurement field, a part of or the entire configuration included in the processing circuit 310, such as the tensor calculation described above, can be used. This can improve the accuracy of the time-resolved measurement. In this case, the distance measuring device 100 can also be called a fluorescence lifetime imaging device or a time-resolved Raman spectroscopic measuring device.

Here, an application example of the distance measuring device 100 according to the above-described embodiment will be described below. FIG. 16 is a schematic diagram of equipment EQP mounted with the distance measuring device 100. As illustrated in FIG. 16, the distance measuring device 100 is accommodated in a semiconductor package PKG. The package PKG can include a substrate to which the distance measuring device 100 is fixed, a lid member such as glass facing the distance measuring device 100, and a conductive connection member such as a bonding wire or a bump that connects a terminal provided on the substrate and a terminal provided on the distance measuring device 100. The equipment EQP may further include at least any of a control device CTRL, a processing device PRCS, a display device DSPL, and a storage device MMRY.

An optical system OPT forms an image on the pixel region 12, and can be, for example, a lens, a shutter, a mirror, or the like. The control device CTRL controls the operation of the distance measuring device 100, and can be, for example, a semiconductor device such as an ASIC. The processing device PRCS processes a signal output from the distance measuring device 100, and can be a semiconductor device such as a CPU or an ASIC. The display device DSPL can be an EL display device or a liquid crystal display device that displays data obtained by the distance measuring device 100. The storage device MMRY is a magnetic device or a semiconductor device that stores data obtained by the distance measuring device 100. The storage device MMRY may be a volatile memory such as an SRAM or a DRAM, or a non-volatile memory such as a flash memory or a hard disk drive. A mechanical device MCHN can include a movable unit or a propulsion unit such as a motor or an engine. The mechanical device MCHN drives components of the optical system OPT for zooming, focusing, and shutter operation, for example. The equipment EQP displays, on the display device DSPL, data output from the distance measuring device 100 and transmits data to the outside by a communication device (not illustrated) included in the equipment EQP. Therefore, the equipment EQP may include the storage device MMRY and the processing device PRCS.

The equipment EQP in which the distance measuring device 100 is incorporated can also be applied to a monitoring camera, an in-vehicle camera mounted on transportation equipment such as an automobile, a railway vehicle, a ship, an aircraft, or an industrial robot, and the like. In addition, the equipment EQP in which the distance measuring device 100 is incorporated can be applied not only to transportation equipment but also to equipment that widely use object recognition, such as an intelligent transportation system (ITS).

According to the present disclosure, it is possible to provide a technology advantageous in improvement of the accuracy of time-resolved measurement.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-177770, filed Oct. 13, 2023, which is hereby incorporated by reference herein in its entirety.

What is claimed is:

1. A distance measuring device comprising: a pixel region including a plurality of pixels; and a processing circuit for generating distance information based on a signal output from the pixel region, wherein
a sequence of generating the distance information includes a plurality of distance measuring periods each for measuring a time from emission of light by a light source to detection of the light reflected on an object by the pixel region,
the processing circuit is configured to perform, for each pixel, tensor calculation on a tensor of two or more dimensions including a first time axis indicating a time at which a distance measuring operation in each distance measuring period is performed, and
the tensor calculation is performed to obtain a calculation result indicating that each detection signal indicating that light is detected is a true detection signal when there is a signal indicating that another ray of light is detected within a predetermined range of the tensor from the detection signal.

2. The distance measuring device according to claim 1, wherein the tensor includes a second time axis indicating timing at which light is detected in each distance measuring period.

3. The distance measuring device according to claim 2, wherein
the predetermined range includes a first range in a direction along the first time axis in the tensor and a second range in a direction along the second time axis in the tensor, and
the tensor calculation is performed to obtain a calculation result that indicates the detection signal is a true detection signal when there is a signal indicating that another ray of light is detected in at least one of the first range and the second range of the tensor from the detection signal.

4. The distance measuring device according to claim 3, wherein a number of elements of the tensor included in the first range and a number of elements of the tensor included in the second range are different from each other.

5. The distance measuring device according to claim 1, wherein
the plurality of pixels are arranged in a matrix, and
the tensor further includes a first space axis indicating a row or a column in which the plurality of pixels are arranged.

6. The distance measuring device according to claim 3, wherein
the plurality of pixels are arranged in a matrix,
the tensor further includes a first space axis indicating a row or a column in which the plurality of pixels are arranged,
the predetermined range further includes a third range in a direction along the first space axis in the tensor, and
the tensor calculation is performed to obtain a calculation result that indicates the detection signal is a true detection signal when there is a signal indicating that another ray of light is detected in at least one of the first range, the second range, and the third range of the tensor from the detection signal.

7. The distance measuring device according to claim 6, wherein a number of elements of the tensor included in the first range and a number of elements of the tensor included in the third range are different from each other.

8. The distance measuring device according to claim 5, wherein the tensor further includes a second space axis indicating a surface on which the plurality of pixels are arranged by being combined with the first space axis.

9. The distance measuring device according to claim 6, wherein
the tensor further includes a second space axis indicating a surface on which the plurality of pixels are arranged by being combined with the first space axis,
the predetermined range further includes a fourth range in a direction along the second space axis in the tensor, and
the tensor calculation is performed to obtain a calculation result indicates the detection signal is a true detection signal when there is a signal indicating that another ray of light is detected in at least one of the first range, the second range, the third range, and the fourth range of the tensor from the detection signal.

10. The distance measuring device according to claim 9, wherein a number of elements of the tensor included in the first range and a number of elements of the tensor included in the fourth range are different from each other.

11. The distance measuring device according to claim 1, wherein the tensor calculation includes any of pattern matching, blob detection, a combination of expansion processing and reduction processing, reduction processing, and thinning processing.

12. The distance measuring device according to claim 1, wherein the tensor calculation includes any of a median filter, a maximum value filter, a minimum value filter, and a moving average filter.

13. The distance measuring device according to claim 1, wherein the tensor calculation includes a convolution operation.

14. The distance measuring device according to claim 1, wherein the tensor calculation includes contour detection processing.

15. The distance measuring device according to claim 1, wherein the processing circuit includes a filter circuit configured to perform the tensor calculation on the tensor, and a generation circuit configured to generate the distance information based on data after the tensor calculation, the data being output from the filter circuit and being obtained in a predetermined number of distance measuring periods among the plurality of distance measuring periods.

16. The distance measuring device according to claim 15, wherein
the generation circuit is configured to generate first distance information and second distance information as the distance information in the sequence, and
a part of the predetermined number of distance measuring periods used for generation of the first distance information among the plurality of distance measuring periods and a part of the predetermined number of distance measuring periods used for generation of the second distance information among the plurality of distance measuring periods are distance measuring periods same as each other.

17. The distance measuring device according to claim 15, wherein the generation circuit is configured to generate, as the distance information, a histogram in which elements arranged in a direction of the first time axis of the data are added.

18. The distance measuring device according to claim 15, wherein the generation circuit is configured to generate the distance information by using calculation of a neural network for the data.

19. The distance measuring device according to claim 18, wherein the calculation of the neural network is performed using a learned model learned using a convolutional neural network-based machine learning method.

20. Equipment comprising: the distance measuring device according to claim 1; and
a processing device that processes a signal output from the distance measuring device.
